(19) United States
(12) Patent Application Publication
(10) Pub. No.: US 2003/0206200 A1
(43) Pub. Date: Nov. 6, 2003

(54) Bar communication

(76) Inventor: Petr Hejl, White Rock (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/426,855

(22) Filed: May 1, 2003

(30) Foreign Application Priority Data
May 1, 2002 (CA) 2,384,404

(51) Int. Cl. G09G 5/00

(52) U.S. Cl. 345/810

(57) ABSTRACT

In communications, there exist various communication ways with different control (WWW, WAP, email, SMS . . . ). Messages are written, sent and received using different user interfaces. With present communication ways it is difficult to connect them mutually and to redirect one communication way into another. Also simple person to person communication tool is missing.

The new solution, suggested in the patent, is to use the bar on the display as a form for unified messaging. The content of this bar communication is created by connecting various communication ways, redirecting one communication way into another communication way and direct bar to bar communication.

This solution puts together simple and user friendly communication environment with powerful content of unified messaging.

### FIELD

The present invention relates to a method of creating simple unified communication.

### BACKGROUND OF THE INVENTION

There exist several different ways of communicating at present. Communications can be effected by, for example, telephone, facsimile, WWW, WAP, email, SMS, ICQ, and instant messaging. Some of the present ways of communicating may be difficult to learn and implement. For example, for people who are not familiar with computers, it may be difficult to send and receive emails using email programs. Alternatively, for other people it may be difficult to write SMS messages using the usual 1-2-3 (tap-tap-tap) keyboard on mobile phones.

The various means of current communication differ from each other significantly. The procedures from a user's point of view between sending and receiving emails is quite different from that of sending and receiving SMS messages. At present different ways of communication are usually not mutually connected by gateways. Thus, it is not generally possible to send receive messages from WWW pages or email to SMS using the usual REPLY functions on mobile phones.

With present ways of communication it is not generally possible to redirect one into another. This redirection is available only for some special cases.

There, in fact do exist solutions for cross communications but only for special situations. For example, it is possible to add some information to SMS message format and so to send emails to SMS and receive them, but this solution is available only for some SMS operators. There does not exist any simple and general solution for the problems, stated above.

### SUMMARY OF THE INVENTION

According to the invention there is provided a simple, unified communication referred to as bar communication. In bar communications, a bar of display is used to control the communication. By using reply recognition, one method of which is disclosed in my co-pending Canadian Patent Application Serial Number 2,382,819 filed on Apr. 22, 2002, it is possible to connect basically any way of communication (with identifiable sender and receiver) and to redirect one way of communication into another. Direct bar to bar communication between two companies, persons or computers is possible. The external form used to implement bar communication is shown in FIGS. 1-4, and that for bar realisation in FIGS. 5-9.

A bar is simple and user friendly. It provides unified control of all the internal ways of communication. A bar may be realised by several methods, described below. The internal structure connects together and can redirect several ways of communication (e.g., telephone, facsimile, WWW, WAP, email, and SMS). A WWW way of communication enables a user to write messages directly into the bar communication files thereby achieving bar-to-bar communication.

### BRIEF DESCRIPTION OF THE DRAWINGS

FIG. 1 is the communication bar form for Row 1 for the status “send”;

FIG. 2 is the communication bar form for Row 1 for the status “receive”.

FIG. 3 is the communication bar form for Row 2;

FIG. 4 is the bar communication home page;

FIG. 5 is the communication bar realization using the running program;

FIG. 6 is the communication bar realization using framed WWW pages;

FIG. 7 is the communication bar realization using a self-displayed WWW window;

FIG. 8 is the communication bar realization as a bar of the browser;

FIG. 9 is the communication bar realization as a bar of the Operating System; and

FIG. 10 is block diagram showing the architecture of the bar communication system.

Communication Bar Form

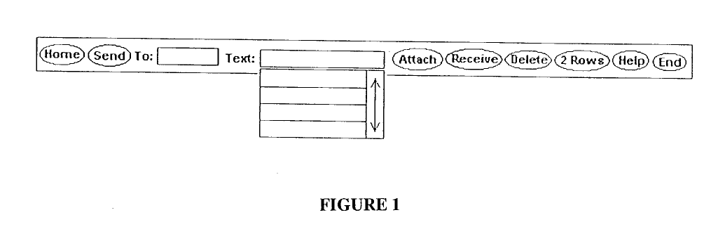

Referring to FIGS. 1-4, the external form of bar communication is a bar, created on the display of the computer or on other device (notebook, handheld computer, mobile phone . . . ). The bar consists of 1-2 rows with each row presenting images, buttons and fields. Buttons are used for control. Each field consists of a title and field window. The field window may be text, checkbox, radio, list, etc.

Basically buttons are clicked on by a mouse or chosen by another position control system of the computer or device. Also voice control of the bar may be realised. In the latter case the user may speak the commands “Send”, “Receive”, where to send, and the text of message. In the future, control of the bar may be achieved by a person's thought process.

The first row of the communication bar may have a “Send” or “Receive” status. FIG. 1 shows the “Send” status. The meaning of the other buttons and fields is as follows:

Button “Home”—points to the home page of the bar communication.

Button “Send”—sends the present message (if written) and then sets the first row to the status Send whether the previous status was “Send” or “Receive” . . . As a matter of format, the “Send” button may also be placed immediately to the left of the “Receive” button.

Field “To”—defines the destination of the present message. The destination can be group or member name, company, person or computer identifier, email address, mobile phone number . . . The field “To” may also contain many such identifications, separated by spaces or commas. The message will be sent to all those identifications. When there is a name of a group in the field “To”, the message will be sent to all the members of the group.

Field “Text”—text to be sent. Below the “text” field the messages previously sent may be displayed as a list.

Field “Attach”—attachment(s) to be sent. When clicking on this button, the bar communication will allow the user to attach file(s) to the message.

Button “Receive”—receives messages (if any), and then sets the first row into the status “Receive” (“shows received messages”) whether the previous status was “Send” or “Receive”. The bar communication may also check, whether there are messages received, in defined intervals. These intervals can have default values or can be defined by the user.

Button “Delete”—deletes selected sent or received messages.

Button “Rows”—defines, how many bar rows will be displayed (1 or 2).

Button “Help”—displays help for the bar communication.

Button “End”—ends the bar communication.

Status “Receive”

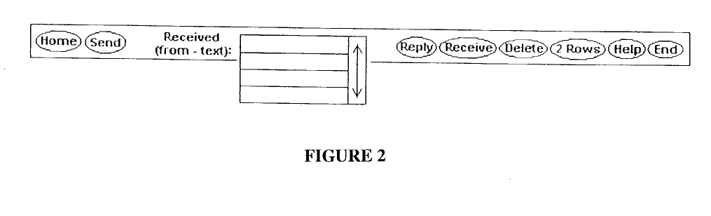

Referring to FIG. 2 in the “receive” status, the first row is the same as in the status “Send” except that the fields “To”, “Text” and “Attach” are replaced by the fields “Received” and the button “Reply”.

Field “Received”—displays received messages. It is a list. Each row in this list contains the identification (e.g. group or member name, company, person or computer identifier, email address, mobile phone number) from where the message was received, and the received text.

Button “Reply”—replies to the message, which was selected by the user in the field “Received”.

Other variants in the design of row 1 may be used such as inclusion of the following:

Image “Logo”—logo of the bar communication.

Button “Call”—to make a telephone call.

Button “Login/Logoff”—is used to login into the bar communication system and to set defined communication values for the user (country, signature . . . ). This button would be used especially on computers used by many people such as in Internet cafes, etc.

Button “Redirect”—is used to redirect the various ways of bar communication to other ways of communication. For example, it is possible to direct WWW messages (bar-to-bar communication) to SMS messages on a user's mobile phone.

Field “Signature”—a text field or list, which enables the user to write the signature or to choose the signature from his/her predefined signatures. The signature is added to the message text. For example, a user may use one signature when writing to family or friends (first name) and another signature for business communications.

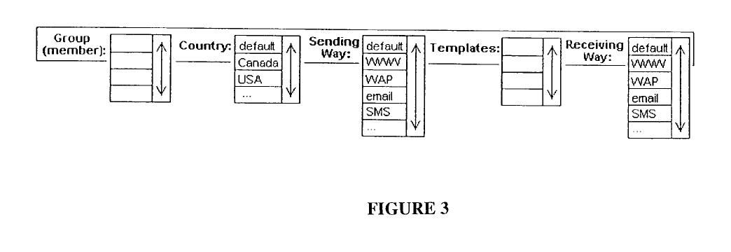

“Row 2” is invisible in the basic status. It appears and disappears using the control button “Rows”. (see FIG. 3).

Field “Groups”—defines to which group(s) or member(s) the message is to be sent. Groups and members themselves as well as their communication identifications (e.g., company, person or computer identifiers, email addresses, mobile phone numbers . . . ) are defined using the bar communication home page.

Field “Country”—defines the country where message are to be sent. The Default value means that either it is not necessary to use the country (e.g. for email) or the country is derived from the user country or the country is derived from the field “To”, e.g. from the telephone number. The “Country” may, for example, be used to avoid the requirement of using when sending to mobile phones the word plus (or 00) and the country phone code.

Field “Sending Way”—defines the communication way that the message is to be sent. Default value means, that the way will be derived from the field “To” and/or text of the first row. For example, when the field “To” contains an email address, the message will be sent via email. When the field “To” contains the telephone number and the field “Text” is empty, a voice telephone call to this number will be initiated. When the field “To” contains telephone number and field Text is not empty, SMS message with text will be sent to this mobile phone.

Other “Sending Way” values may be telephone, facsimile, WWW, WAP, email, SMS, ICQ, instant messaging . . . If the user defines the “Sending Way” equal to WWW, the message will be recorded into the bar communication files of the user and of the receiver, so that this will be the form of bar-to-bar communication. The message will be visible in the bar of the user and of the receiver (the person with whom the user communicates).

Field “Templates”—contains templates of message texts. These may be either default templates or templates defined by the user. Templates are defined using the bar communication home page.

Field “Receiving Way”—defines the communication way the message (reply) is to be received. Default value means either that the present home page user defined way is valid, or that the reply will be received in the same way, in which the original message was sent. Nondefault value of Receiving Way means, that the reply will be received in this chosen way. Other Receiving Way values may be the telephone, facsimile WWW, WAP, email, SMS, ICQ, instant messaging . . . If the user defines the “Receiving Way” equal to WWW, the reply will be delivered to the field “Received” of the first row of the bar communication. If the user defines the “Receiving Way” equal to SMS, the reply will be received via SMS on user's mobile phone.

Remark:

In the realisation of the Row 1 and Row 2 of the communication bar, some above described parts may be missing or have (other) abbreviations.

Bar Communication Home Page

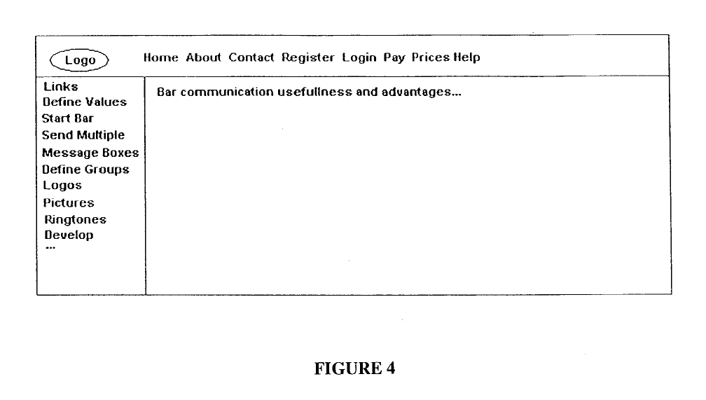

Referring to FIG. 4, the bar communication home page may be displayed in Internet (as a WWW page) or in a program window. The Home page and the following pages enable the definition of user values such as country, email address, mobile phone number, default ways to send and receive messages, default redirecting—where to receive messages when leaving the computer. From the home page and the following pages, the user can send multiple messages. He/she can see the message boxes such as IN, OUT, TEMPLATES, TRASH, write templates, delete messages, empty trash. Groups and members for group messaging can be defined. Also logos, pictures, ringtones etc. can be chosen to be sent via the communication bar . . .

Communication Bar Realisation

The bar of the bar communication may be realised by program, frames, WWW window, browser bar and operating system bar.

Running Program

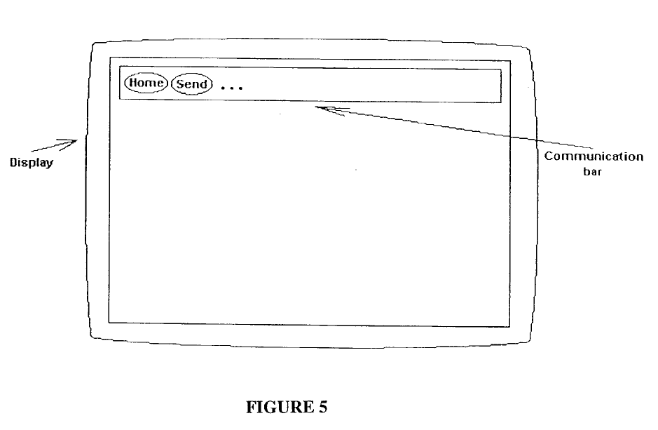

Referring to FIG. 5, the program is installed on computer, a notebook, a handheld computer, a mobile phone, etc. This program creates the bar as well as the internal structure and realizes the interfaces.

Framed WWW Pages

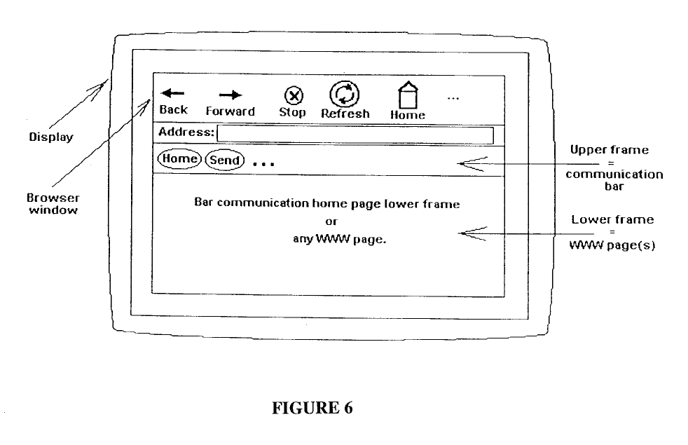

Referring to FIG. 6, the bar communication home page is framed. In the upper frame there is the communication bar. In lower frame initially main part of the home page shown in FIG. 4 will be displayed. It includes a link to the list of frequently used WWW pages and (if possible) to user's favorite links. These links will be used by the user to go to other WWW pages. These pages will be visualised in the lower frame. Thus, after visiting the bar communication home page, the communication bar will be visible all of the time, the user clicks on links in the lower frame.

Self-Displayed WWW Window

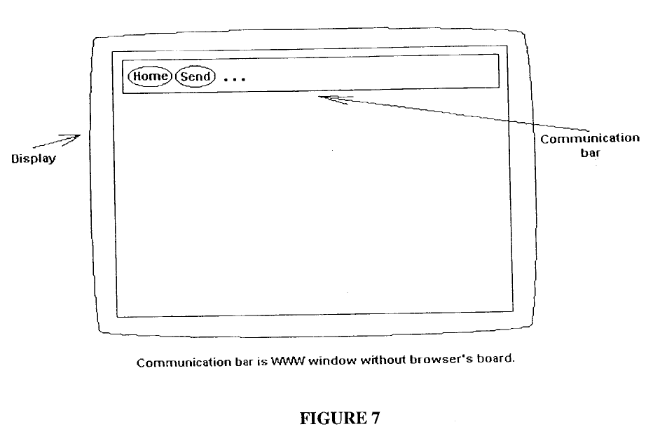

Referring to FIG. 7, on the bar communication home page there is a link, which launches the communication bar into a self-displayed WWW page (e.g., a new browser session).

Bar of the Browser

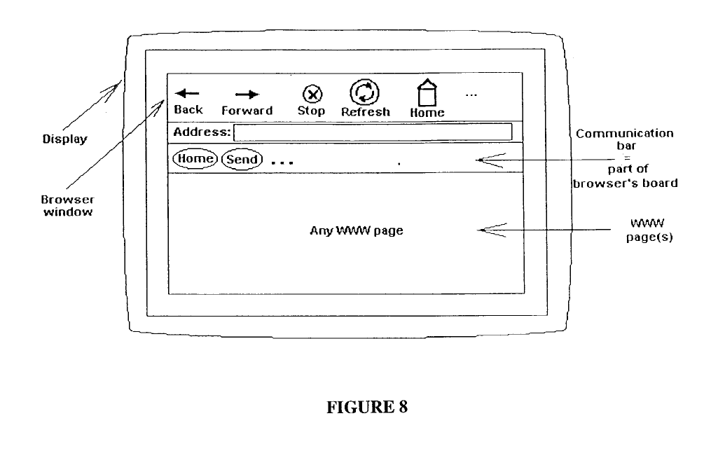

Referring to FIG. 8, the communication bar is part of the board of the WWW browser.

Bar of the Operating System

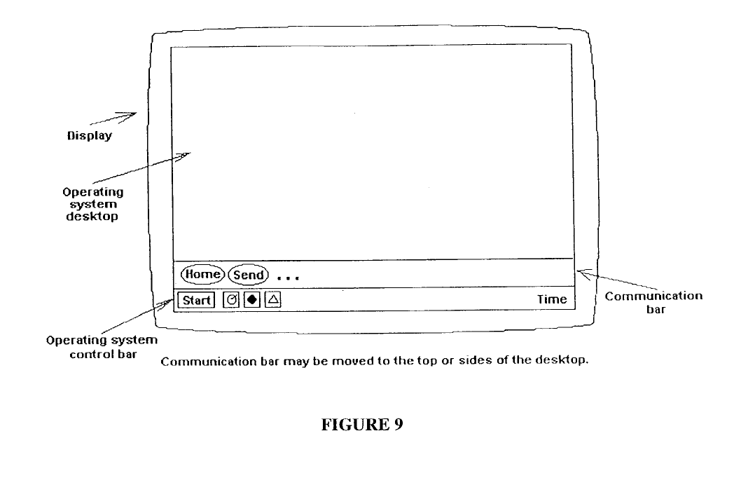

Referring to FIG. 9, the communication bar is part of the operating system (e.g., Windows, Unix, etc.). After starting, the bar appears (by default or by the user's choice) on the display of the computer or of the device. User is allowed to hide and/or show the communication bar.

Internal Structure

Internally, the bar communication consists of programs, files and interfaces.

Programs

Three types of programs exist in the bar communication, namely, user programs, processes, interface programs.

User Programs—display the communication bar and the home page. The user programs enable the user to define data about themselves (communication identifier, email address, phone number . . . ), to define default values for the communications (sending way, receiving way, redirecting between ways when coming to the computer and leaving the computer . . . ), to pay for the communications . . .

Processes—transform messages between user programs and interface programs.

Interface Programs—perform the interfaces, i.e. send messages out from the bar communication system and receive messages into the bar communication system.

Files

The following four types of files exist in the bar communication, namely, control, user, message, and interface.

Control Files—contain items to define the control of the bar communication (e.g. sizes of the bar).

User Files—contain data about the user (name, identifier, email address, mobile phone number . . . ), user defined values for the communications (default sending way, receiving way, redirecting ways when coming to the computer and leaving the computer), data about payments for the communications . . .

Message Files—contain the messages. Basically four message files (boxes) are available: in (received), out (sent), templates, trash. There may be user defined files (boxes), e.g. with family, friends, business . . . messages.

Interface Files—contain definitions of interfaces (protocols, ports, addresses, numbers, etc.).

Interfaces

Inside the bar communication system, there is an interface for each way of sending and receiving, e.g. for telephone, facsimile, WWW, WAP, email, SMS . . . These interfaces may be realised, for example, as follows:

by writing messages directly into the message files (WWW, WAP way)

by fixed communication lines (to operator's SMS centers)

by temporary communication lines (for voice telephones)

by physically connecting the devices to the bar communication system (connected mobile phones)

using Internet client (email client for receiving and sending)

via Internet (TCP/IP)

Usage

Bar communication may be used for voice communications, messaging . . . And moreover there is one important usage. When the user wants to order some things online, to be delivered to their communication device (e.g. logos, pictures or ringtones for mobile phone), he/she can order this on some WWW page (e.g. on the bar communication home page) and define on the communication bar, where to deliver the ordered things.

Advantages

Advantages of this solution are the following:

1. Bar

Using the bar for the unified communications, which enables simple and user friendly control. The user has the communication bar available all the time at his/her display, the bar may be seen even when running other programs.

2. General Connection

Generally it is possible to connect any communication way (which has identifiable senders and receivers) into the bar communication. This is enabled by applying the method by which a message received along a given line is linked with that line so that any response travels along the same line to the sender.

3. Redirecting

It is possible to redirect the (unified) bar communication to the device, which the user has available at present time. For example, it is possible to redirect the bar communication from desktop computer to notebook, handheld computer, mobile phone . . . and vice versa.

4. Direct Bar to Bar Communication

Sending and receiving messages between two persons can be done directly from bar to bar. In this case messages are only recorded in the files of the bar communication system.

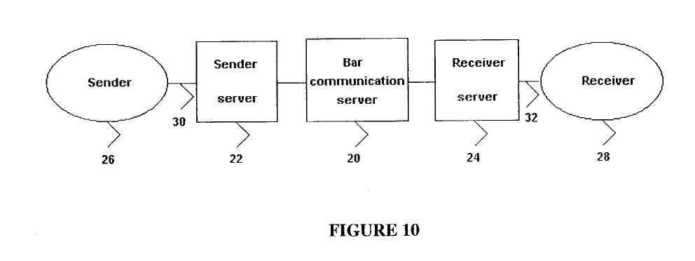

Referring to FIG. 10, a bar communication server 20 is positioned physically between a sender server 22 and a receiver server 24. A sender 26 sends a message over line 30 which is received by the sender server 22 and then transmitted to the bar communication server 20 which transforms the message format to be the same as that of the Receiver 28. The transformed message is sent to the Receiver's server 24 where the transformed message is sent along line 32 to the Receiver. The sender server 22 and the receiver server 24 may be any communication server (email, SMS, etc.).

I claim:

1. A method of unified communication, comprising:
(a) providing a communication bar having rows for sending and receiving messages, which can overlap according to a status of said communication bar;
(b) providing a connection for specifying various communication ways for sending and receiving said messages;
(c) providing direct bar to bar communication by linking a received message with a line along which said message has been sent so that a reply travels along said line.
